(19) United States
(12) Patent Application Publication
(10) Pub. No.: US 2002/0143623 A1
(43) Pub. Date: Oct. 3, 2002

(54) Method for personalized drive-thru service

(76) Inventor: J. Don Dayley, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/823,785

(22) Filed: Mar. 29, 2001

(51) Int. Cl. G05B 23/02; G06F 17/60

(52) U.S. Cl. 705/14; 340/5.9

(57) ABSTRACT

A method for providing a custom menu for a drive-thru customer has a first step of scanning the customer automobile license plate. The unique license plate number will serve as an identifier for the customer. The customer menu selections will be recorded in a customer profile corresponding to the unique license plate number. On subsequent visits to the drive-thru, scanning of the license plate will allow for retrieval of the customer profile and for displaying a customized menu featuring past menu selections to the customer. The drive-thru customer's buying trends over time may also be discovered through practice of the invention.

### FIELD OF THE INVENTION

The present invention is related to the field of drive-thru service. In particular, the present invention is related to methods for providing personalized drive-thru service by providing custom menu options.

### BACKGROUND OF THE INVENTION

Modern society in western countries revolves to a large extent around the automobile. People tend to spend ever increasing amounts of time in their vehicles. Retailers have responded to this trend by offering consumers automobile-based shopping opportunities in the form of drive-thru shopping. Although many other examples exist, this is most common in the form of restaurant drive-thru service.

A typical drive-thru restaurant configuration of the prior art is shown in FIG. 1 where customers drive their automobiles 2 into a “drive-thru lane” 4 that has a menu board 6 and a vehicle sensor 7, which may comprise a compressible ridge in the drive-thru lane 4. As the car 2 pulls up to the menu board 6, the sensor 7 indicates to in-store personnel or an automated server that a customer has arrived. The in-store personnel or server may greet the customer over a two-way microphone. The customer scans the menu board 6, makes a selection, and announces the selection over the two-way microphone. The customer then drives up to a pick-up window 8, where he pays for and is delivered his order. With the transaction thus completed, the customer drives away.

There are several unresolved problems with drive-thru retail shopping. In particular, customers are required to scan relatively large menu boards from the vantage point of being seated in a car. The menu boards, particularly for fast food establishments, may contain many items. These and other factors make selection difficult and time consuming for the customer. This translates to slower service for the retailer, lower customer satisfaction, and resultant lower retailer revenue.

Market research indicates that consumers respond favorably to personalized service. Customers are more likely to return to a retailer, or recommend the retailer, and are more likely to spend more with the retailer when they receive such personalized service. Because drive-thru customers have virtually no face-to-face interaction with the retailer personnel, it is difficult to provide personalized service. This has led to low customer satisfaction for drive-thru retailing.

These and other problems have been addressed in markets other than drive-thru retailing. In particular, fields such as air travel, grocery shopping, and on-line shopping have utilized marketing programs that provide personal services by having shoppers enroll in “frequent buyer” programs. These programs allow the vendor to track the customer's purchasing habits. Even these programs, however, have unresolved problems. In particular, these programs require users to take action to enroll. Often, this results in low enrollment and lowers the effectiveness of the program. Additionally, these programs have proven impossible to implement because of the minimal contact that occurs with a drive-thru customer.

These and other problems remain heretofore unresolved, and therefore a need for methods for delivering personalized service exists for drive-thru customers.

### SUMMARY OF THE INVENTION

The present invention comprises an improved method for providing customized menu service to a drive-thru customer in a vehicle. The method generally comprises the steps of scanning a unique customer identity code from the customer vehicle during a first visit to the drive-thru, creating a customer profile corresponding to the unique customer identity, and storing the customer menu selections in the customer profile. During subsequent visits to the drive-thru, the customer identity code will be scanned, the customer's customer profile retrieved, and a custom menu created from the customer profile and displayed to the customer. Thus practice of the present invention allows for personalized service to drive-thru customers in an automatic and efficient manner.

In a preferred embodiment of the method of the invention, a machine readable customer identity code means comprises a customer license plate number. Other machine readable identity means may comprise identity badges attached to the car, bumper stickers attached to the car bumper, stickers attached to the car window, or the like. Many additional embodiments of machine readable unique customer identity codes may be comprised of alphanumeric codes, bar codes and the like.

The various steps of the method of the invention are well suited for execution by a computer. Accordingly, an additional embodiment of the invention comprises a computer program product for performing the steps of the method of the invention.

The various embodiments of the method and computer program of the invention thereby solve several of the heretofore unresolved problems in the art in a novel and efficient manner. In particular, a drive-thru retailer is able to provide customized service to each of its individual customers without requiring any personal interface and without requiring action on the part of the customer. Customers will be able to quickly view a custom menu that is based on their previous menu selections and tailored to their preferences. Through practice of the present invention, drive-thru vendors may be able to speed service time, build brand loyalty, increase customer satisfaction, and thereby increase revenue.

The above brief description sets forth rather broadly the more important features of the present disclosure so that the detailed description that follows may be better understood, and so that the present contributions to the art may be better appreciated. There are, of course, additional features of the disclosure that will be described hereinafter that will further describe the subject matter of the invention. In this respect, before explaining an embodiment of the disclosure in detail, it is to be understood that the disclosure is not limited in its application to the details of the construction and the arrangements set forth in the following description or illustrated in the drawings. The present invention can be implemented in other embodiments and can be carried out in various ways, as will be appreciated by those skilled in the art. Also, it is to be understood that the phraseology and terminology employed herein are for description and not limitation.

### BRIEF DESCRIPTION OF THE DRAWINGS

FIG. 1 is a perspective view of an automobile at a retailer drive-thru as is typical of the prior art.

FIG. 2 is a flowchart illustrating steps of an embodiment of the method and software program product of the invention.

FIG. 3 is a schematic useful for illustrating a computer program product embodiment of the invention.

FIG. 4 is a schematic of a network configuration for illustrating an embodiment of the invention.

### DETAILED DESCRIPTION

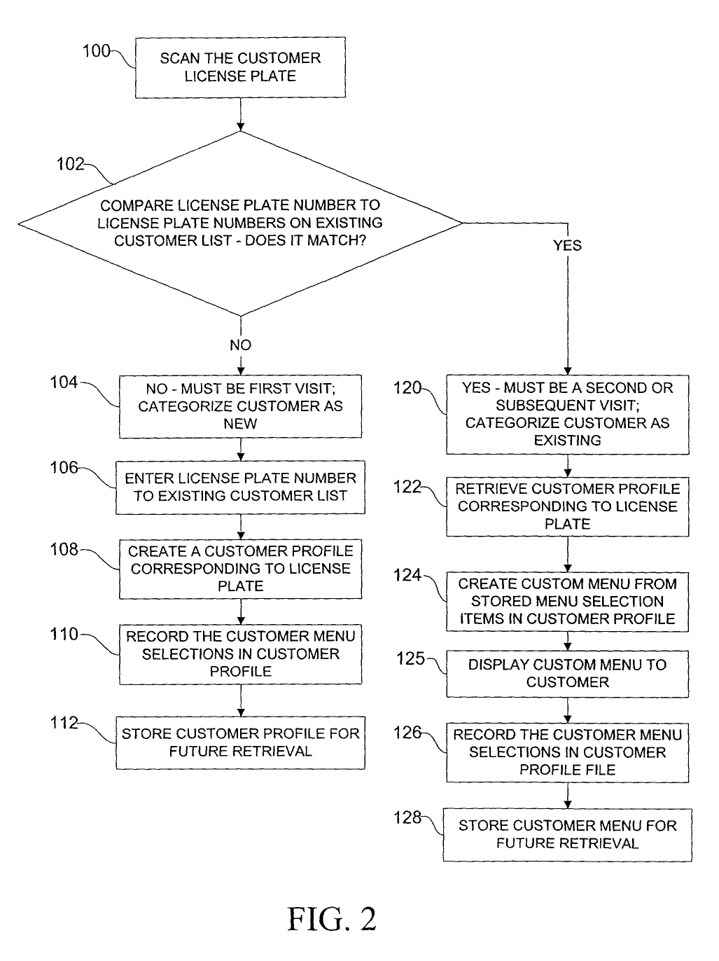

Turning now to the drawings, a flow chart describing the steps of a preferred embodiment of the method and computer program product of the invention for providing custom menu service to a drive-thru customer is shown in FIG. 2. As an initial step, a customer license plate is scanned as the customer automobile pulls near a menu board of a drive-thru retailer (100). Scanning may occur using any of a variety of methods that are generally known in the art, with a preferred method comprising providing an electronic scanning device that emits light rays and measures reflections from those emitted light rays. The reflections are then interpreted to detect images.

Such methods and devices can be used to detect characters such as alphanumeric license plate characters. Scanning means are preferably located at the drive-thru in a position and oriented such that they are positioned to read the license plate of a vehicle when the vehicle is stationary near the menu board. The scanning means may also comprise logic for zeroing in on the license plate number. Preferably, the scanning means are directed to the rear license plate, as many vehicles do not have a front plate.

The scanned license plate number will serve as a unique customer identity code. The method and program product of the invention could of course be practiced using unique customer identity codes contained on readable identity means other than a customer license plate. By way of example, other machine readable identity means that are attached to the customer vehicle and that contain a unique customer identity code could comprise a readable badge, a readable label such as a window or bumper sticker, an optical reflector, a radio transmitter, or the like. Further, the identity means may be attached to a car bumper, window, body, or other car portion.

It will also be understood that the unique customer identity code contained on the machine readable identity means could be other than a license number. Indeed, almost any unique code may be used within the practice of the invention, including but not limited to bar codes, alphanumeric combinations, and the like. A license plate is preferred as a machine readable identity means in the various embodiments of the invention, however, as it is universally present on customer cars. It advantageously requires no action on the part of the customer to install or maintain. It further does not require a customer to voluntarily enroll or submit to any customer profiling. Additionally, if a state identifier is read from the license plate, the license plate is unique nationwide. Embodiments of the invention may be practiced that do not comprise reading a state identifier, however, if the invention is to be practiced only within a single state. That is, as most fast food customers make the vast majority of their purchases at a few restaurants, it may be sufficient to read only license plate numbers without state identifiers.

It is noted that as used herein the term “machine readable” is intended to refer to characters or signals that may be interpreted by a machine. As an example, machine readable characters may comprise alphanumeric characters, bar codes, optical reflector patterns, radio signals, audio signals, infrared signals, cellular signals, and the like.

Referring once again to FIG. 2, after scanning the license plate (100), a determination is made whether the customer is an existing customer or a new customer (102). Specifically, the license plate number is compared to an existing customer list that contains a plurality of existing customer license plate numbers (102). If no match is found, it is concluded that the customer has not had his license plate scanned before, and is therefore categorized as “new” (104). The new customer license plate number is added to the existing customer list (106). Thus on his next visit the customer's license plate number will be found on the existing customer list, and he will be identified as an existing customer.

After categorizing the customer as a new customer, a customer profile is then created corresponding to the customer license number (108). The customer profile generally comprises a file shell into which data can be stored. The customer's menu selections are then recorded in the customer profile (110). Thus, by way of example, if a customer were to select a double cheeseburger, vanilla shake, and fries from a main menu board, these selections would be stored in the customer profile.

The recording of the customer's menu selections may occur by detecting the selections from the retailer's order entry system. By way of example, the customer may announce his menu selection over a menu board microphone that links to a retailer order entry server, which may be a person or a computer device, in the retailer building. The order entry server then enters the menu selections into a retailer order entry system for processing. The processing of the selections will comprise at least computing a price for the items, and may comprise displaying the order on an internal inventory display for order filling.

The customer profile corresponding to the customer license plate into which the customer's menu selections have been placed is then stored for future retrieval (112). Storage of the customer profile may comprise, by way of example, placing the menu file into a data repository and/or a database.

If the license plate comparison to the existing customer list had resulted in a match upon the customer arrival at the drive-thru, this embodiment of the method and program of the invention would conclude that the customer has been through the retailer drive-thru before, and should therefore be categorized as an “existing” customer (120). That is, a positive match indicates that the customer has been through the process generally described in nodes (104-112), and that a customer profile with previous menu selections stored therein must have been previously created. This customer profile corresponding to the customer license plate is then retrieved for the existing customer (122).

After the step of retrieving the customer profile for the existing customer (122), a custom menu can be created (124). The term “custom menu” as used herein is intended to refer to a listing of items available that have been specifically selected for a particular customer. Preferably, the custom menu comprises at least a partial listing of previous menu selections stored in the customer profile. After creation, the custom menu is displayed to the customer using display means that are visible from his vantage point seated in the car (125).

The display means may comprise, by way of example, a video display screen such as a CRT or LCD screen proximate to the main menu board. By way of additional example, the main menu board may have a portion that comprises the display means. By way of still further example, the main menu board itself may comprise a video display screen that is automatically changed to display the custom menu.

Practice of the present invention thereby provides personalized customer service for drive-thru customers that was heretofore impossible. Customers are presented with an abbreviated custom menu tailored to them. The method and computer program product advantageously offer the customer a less cluttered and quicker selection option that will speed service, increase customer satisfaction, and thereby result in increased revenue for the retailer. Further, the preferred embodiment of the invention that comprises utilizing an existing license plate as a unique customer identity solves problems of the prior art related to achieving high enrollments in marketing programs.

In a subsequent step of this embodiment of the invention, the customer's menu selections, whether made from the custom menu or the larger main menu, are recorded in the customer profile (126), which is in turn stored for future retrieval (128). When retrieved during a subsequent visit to the retailer by the customer, the customer profile will contain the menu selections from this previous visit for creation of a new custom menu.

It is noted that the customer profile within the various embodiments of the invention may comprise menu selection items from more than the single previous customer visit. Indeed, it will be appreciated that the method and program product of the invention allow for powerful marketing capabilities in that a customer's buying habits may be tracked over time with trends detected. The retailer may create innovative custom menus designed to capitalize on these trends. Accordingly, an additional embodiment of the invention comprises the additional step of providing a custom marketing offer to the customer with the custom menu. The term “custom marketing offer” as used herein is intended to refer to a marketing offer offered only to selected customers based on review of their customer profiles.

As a first example of a custom marketing offer, if a customer's buying habits were tracked through ten restaurant visits and the customer purchased a double cheeseburger seven times and a single cheeseburger three times, a custom marketing offer may comprise offering the customer both choices on his custom menu, with a double cheeseburger discounted to encourage purchase of this larger ticket item.

As a second custom marketing offer example, review of a customer profile may indicate through prior menu selections that the customer is health conscious in that she regularly orders light menu items. When the retailer introduces a new light calorie menu item, a review of this customer's customer profile could identify her based on her buying habits as a likely purchaser of that new item. On the customer's next visit, a custom marketing offer could comprise offering this new item on her custom menu as a suggested item. Additionally, the suggested item could be offered at a special discounted price.

As a third custom marketing offer example, an additional embodiment of the method and computer program product of the invention will comprise the additional step of recording the time of a customer purchase in the customer profile. This time data may be used for a number of marketing related purposes. As an example, a review of a customer profile may indicate that the customer frequents the restaurant only at night. Additional steps of this invention embodiment would then target this customer with a custom marketing offer providing discounted breakfast offers on his custom menu to encourage additional business from him.

As still an additional custom marketing example, it may be discovered from a review of a customer profile that a once regular customer has not frequented a drive-thru for an irregularly long interval. When this customer does finally return to the drive-thru, a personalized message such as “Welcome back, we haven't seen you in over a month” may be presented, along with a “welcome back” discount. It will be appreciated that time of purchase data can also be used for many additional valuable purposes within the invention as claimed.

Further, an analysis of a customer's buying trends as stored in his customer profile may be useful for comparison to other known buying trends. This practice is generally referred to as “collaborative filtering”, and has proven to be successful in other markets. These and other marketing methods could not before the present invention be practiced on a retailer's drive-thru customers. Prior to the present invention such methods and programs were not practical for practice with drive-thru customers as there was no way to identify an individual customer. The present invention makes this possible.

As an example of collaborative filtering, analysis of a plurality of individual custom menus may indicate that purchasers of three particular items are very likely to purchase a fourth particular item. A search could then be made of customer profiles to identify customers that regularly purchase the first three items but not the fourth. These customers would be identified as likely purchasers of the fourth particular item, and that item could be suggested to them in a custom marketing offer on their individual custom menus during future visits to the retailer.

In addition to custom marketing offers intended to encourage increased and more frequent purchasing, embodiments of the method and computer program of the invention can provide a novel tool for building customer loyalty and thereby increasing revenue. An additional embodiment of the method and computer program of the invention comprises subsets of steps useful for these purposes. A first subset of steps will comprise awarding points for each visit or for each dollar spent to the customer. These “award points” may be accumulated towards the award of prizes or free items. The award points may be summed for a particular purchase, and added to the customer's total points stored in her customer profile. The award point total may then be displayed on her custom menu during visits to the retailer. When she has accumulated a required number of points for an award, the custom menu may suggest that she cash in her points towards purchase of a particular item.

This general method of awarding frequent customer points based on frequency and volume of purchases has generally proven to be successful in other markets. Prior to the present invention, however, such methods were impossible for practice with drive-thru customers due to the difficulty in identifying and personally interacting with the particular customer. Thus, the present invention has solved heretofore unresolved problems in the art.

It will be appreciated that certain embodiments of the method and computer program of the invention will prove most valuable only after a considerable amount of data has been entered into the customer profile. Accordingly, an additional embodiment of the invention will comprise the additional step of recording customer menu selection data in the customer profile a plurality of times before presenting the customer with a custom menu. Preferably, customer menu selection data from at least ten customer visits will be stored prior to a first presentation of a custom menu.

It will also be appreciated that various of the embodiments of the present invention are well suited for practice in the form of a computer program for causing a computer to perform the steps of the method as described herein. It will therefore be understood that embodiments of the present invention may comprise computer program products comprising a computer usable medium having computer readable program code embodied in the medium that when executed causes a computer to execute the steps of the embodiments of the method of the invention. The term “computer readable medium” as used herein is intended to refer to any medium that may be read by a computer device. By way of example and not limitation, a computer readable medium may comprise a magnetic medium, an optically readable medium, a flash memory device, embedded circuitry, or the like.

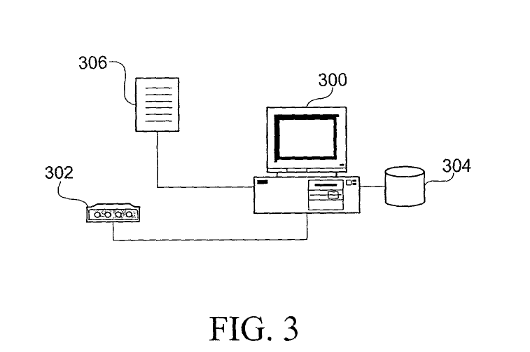

In further illustration of an embodiment of the computer program product of the invention, reference is made to the schematic of FIG. 3. An embodiment of the computer program product of the invention comprises computer readable instructions embedded in a medium residing in the computer 300. The computer readable instructions when read cause the computer 300 to cause the scanning means 302 to scan the license plate of a customer vehicle in a drive-thru during a first visit to the drive-thru. The computer 300 then creates a customer profile on a data repository 304, and assigns the license number to the customer profile as a unique identity code. The user menu selections made from a drive-thru main menu (not illustrated) are then recorded by the computer 300 in the customer profile on the data repository 304.

During each of a plurality of subsequent visits to the drive-thru, the computer 300 will direct the scanning means 302 to scan the customer license number, and will retrieve the corresponding stored customer profile from the data repository 304. The computer 300 will then create a custom menu from the stored menu selection items in the customer profile, and will display the custom menu to the customer using the display means 306.

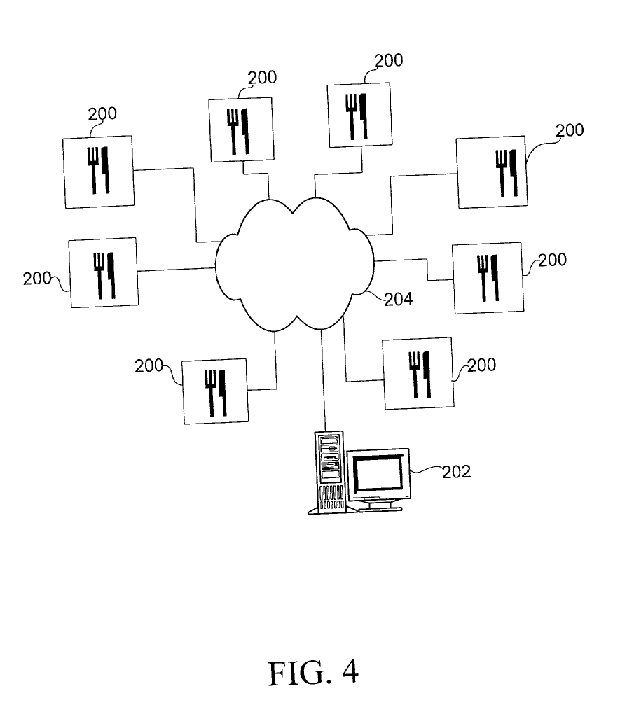

It will also be appreciated that the method and computer program of the invention may be practiced with a plurality of vendors. In particular, an embodiment of the present invention will prove to have particular utility for practice with fast food franchises that may have a plurality or even a multiplicity of individual retail establishments. For practice of the method and computer program of the invention under such circumstances, the invention embodiment will utilize a communications network linking at least a central computer to each of the plurality or multiplicity of individual retail outlets. FIG. 4 is a schematic of such a configuration, in which a plurality of restaurants 200 is operably connected to a central computer 202 through a network 204. Advantageously, a customer profile can be obtained from the central computer 202 for a customer who may appear at any of the restaurants 200.

The central computer 202 may perform various of the steps of the invention as described herein and may store the individual customer profiles. A central data repository may be contained within or connected to the central computer 202 for storing the customer profile and existing customer list. Or, each individual restaurant 200 may have a computer for performing various of the steps of the invention as described herein, except that the customer profiles may remain stored on the central computer 202 for centralized access, processing, and retrieval. It will therefore be appreciated that the term “a computer” as used herein may actually refer to a plurality of computer devices operably connected to one another.

It is also noted that although a specific invention embodiment is being described herein with reference to an automobile passing through a drive-thru, it will be appreciated that the invention may be practiced under a number of different configurations. It will thus be appreciated that as used herein the term “vehicle” may refer to a number of machines for transportation other than cars, trucks, and the like. As an example, planes, nautical vessels, and trains comprise vehicles as used herein.

Further, a “drive-thru” as used herein is not limited to retailers such as a food retailer, but instead may generally comprise any facility practical for providing service to a customer while the customer remains in a vehicle. Indeed, those knowledgeable in the art will appreciate that the invention as claimed may have utility in a multiplicity of “drive-thru” facilities, including but not limited to, drive-thrus that may be present at gas stations; grain elevators; shipping locks, terminals, and canals; airport gates; freight terminals; and the like.

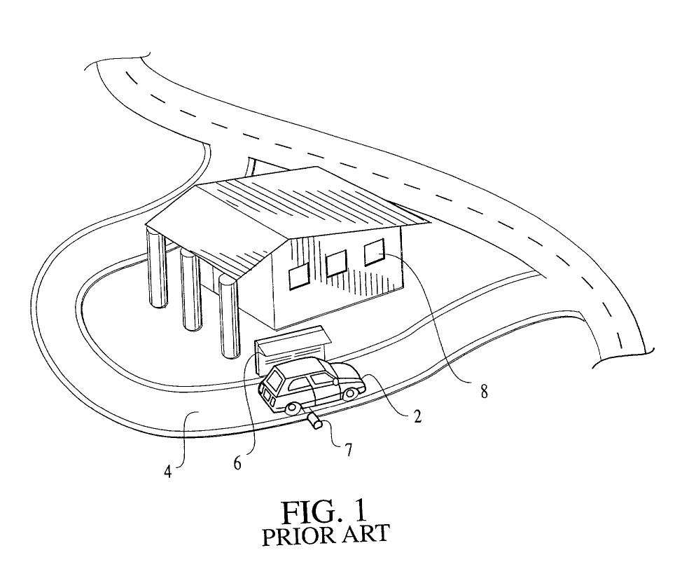

In this sense, it will additionally be appreciated that the term “menu” as used herein is not intended to be limited to food items, but instead refers to a list of offerings. A “main menu” need not comprise a menu board as illustrated in FIG. 1, but instead may comprise any main listing of offerings available to a customer in a vehicle such as a catalog, display in the vehicle, or the like.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

Various features of the invention are set forth in the appended claims.

What is claimed is:

1. A method for providing customized menu service for a drive-thru customer in a vehicle, the customer making menu selections from a main menu the method comprising the steps of:
scanning a unique customer identity code from a machine readable identity means attached to the customer vehicle during a first visit to the drive-thru;
creating a customer profile corresponding to said unique customer identity code;
recording the user menu selections from the main menu during said first and subsequent visits in said customer profile;
scanning said unique identity code from said machine readable identity means during subsequent visits to the drive-thru;
retrieving said customer profile corresponding to said unique customer identity code;
creating a custom menu from said customer profile; and,
displaying said custom menu to the customer during said subsequent visits.

2. A method as defined by claim 1 wherein said machine readable identity means comprise a license plate, and said unique customer identity code comprises a license plate number.

3. A method as defined by claim 1 wherein said machine readable identity means comprise a machine readable badge.

4. A method as defined by claim 1 wherein said machine readable identity means comprise a machine readable bumper sticker.

5. A method as defined by claim 1 further comprising the steps of:
using the customer menu selections from said first visit to create a suggested new item list, and,
displaying said suggested new item list to the customer during said second visit.

6. A method as defined by claim 1 wherein said step of scanning a unique customer identity code further comprises scanning said machine readable identity means attached to the customer vehicle using a scanning means comprising an electronic sensing device capable of emitting light rays and receiving reflections of said emitted rays, said electronic sensing device being capable of detecting characters.

7. A method as defined by claim 1 wherein said step of displaying said custom menu comprises displaying said custom menu using display means proximate to the main menu.

8. A method as defined by claim 1 wherein said method further comprises the step of providing a custom marketing offer with said custom menu.

9. A method as defined by claim 8 wherein said step of providing a custom marketing offer with said custom menu comprises the steps of:
awarding points to the customer based on customer menu selections during said first and subsequent visits;
storing a total number of said points in said customer profile; and
displaying said total number of points with said custom menu during said subsequent visits.

10. A method as defined by claim 8 wherein said step of providing a custom marketing offer with said custom menu comprises offering a discounted purchase price on an item not on said custom menu.

11. A method as defined by claim 1 wherein said method further comprises the step of recording a time value corresponding to the customer menu selections made during said first visit.

12. A method for providing customized menu service to a drive-thru customer in a vehicle, the customer making menu selections from a main menu, the method comprising the steps of:
scanning a license plate number from the customer vehicle with scanning means during a first visit to the restaurant;
creating a customer profile corresponding to said license plate number;
recording the user menu selections from the main menu made during said first visit in said customer profile;
recording a time value corresponding to the time the customer menu selections are made in said customer profile;
scanning said license plate number from the customer vehicle during each of a plurality of subsequent visits to the drive-thru with said scanning means;
recording menu selections made by the customer during said each of a plurality of subsequent visits in said customer profile;
creating a custom menu using the menu selection items stored in said customer profile;
creating a custom marketing offer for the customer using the menu selection items stored in said customer profile; and,
displaying said custom menu and said custom marketing offer to the customer during said each of a plurality of subsequent visits to the restaurant.

13. A method for providing a custom menu to a drive-thru customer in a vehicle making menu selections, the method comprising the steps of:
scanning a unique customer identity code from a machine readable identity means attached to the customer vehicle;
comparing said customer identity code to a plurality of existing unique customer identity codes on an existing customer list to determine whether said unique customer identity code matches any of said plurality of existing unique customer identity codes;
categorizing the customer as a new customer if said unique identity code does not match any of said existing unique customer identity codes;
entering said unique customer identity on said existing customer list if the customer is categorized as a new customer;
creating a unique customer profile corresponding to said unique customer identity code if the customer is categorized as a new customer;
storing the customer menu selections made by said new customer in the customer profile for future retrieval;
categorizing said customer as an existing customer if said unique customer identity code matches any of said existing unique customer identity codes;
retrieving a customer profile corresponding to said unique customer identity if the customer is categorized as an existing customer;
creating a custom menu from said customer profile if the customer is categorized as an existing customer, said custom menu comprising previous selection items made by said existing customer;
displaying said custom menu to said existing customer;
recording menu selections made by said existing customer in said customer profile; and,
storing said customer profile for said existing customer for future retrieval.

14. A method as defined by claim 13, wherein said machine readable identity means comprise a license plate.

15. A computer program product for providing a custom menu to a drive-thru customer in a vehicle making menu selections from a main menu, the program product comprising a computer usable medium having machine readable program code embodied in the medium that when executed causes a computer to:
cause scanning means to scan a unique customer identity code from a machine readable identity means attached to the customer vehicle during a first visit to the drive-thru;
create a customer profile corresponding to said unique customer identity code;
record the user's menu selections from the main menu during said first visit in said customer profile;
scan said unique customer identity code from said machine readable identity means during a second visit to the drive-thru;
create a custom menu from said user menu choices stored in said customer profile; and,
display said custom menu to the customer during said second visit to the drive-thru.

16. A computer program product as defined by claim 15 wherein said machine readable identity means attached to the customer vehicle comprises a license plate.

17. A computer program product for providing customized menu service to a restaurant drive-thru customer in a vehicle making menu selections from a main menu, the program product comprising a computer usable medium having machine readable program code embodied in the medium that when executed causes a computer to:
scan a license plate number from the vehicle during a visit to the restaurant;
create a customer profile corresponding to said scanned license plate number;
record the user menu selections from the main menu made during said visit in said customer profile;
scan said license plate number from the vehicle during each of a plurality of subsequent visits to the restaurant;
record menu selections made by the customer during said subsequent visits to the restaurant in said customer profile;
create a custom menu from said customer profile, said custom menu comprising menu selection items stored in said customer profile; and,
display said custom menu to the customer during said subsequent visits to the restaurant.

18. A computer program product for providing a custom menu to a drive-thru customer in a vehicle making menu selections, the computer program product utilizing scanning means comprising an electronic sensor for emitting light rays and interpreting images from the reflections of the emitted rays, the computer program product comprising a computer usable medium having machine readable program code embodied in the medium that when executed causes a computer to:
cause the scanning means to scan a unique customer identity code from a machine readable identity means attached to the customer vehicle;
compare said unique customer identity code to a plurality of existing unique customer codes on an existing customer list stored in a data repository connected to the computer to determine whether said unique customer identity code matches any of said plurality of existing unique customer identity codes;
categorize the customer as a new customer if said unique customer identity code does not match any of said existing unique customer identity codes;
add said unique customer identity code to said existing customer list if the customer is categorized as a new customer;
create a customer profile corresponding to said unique customer identity code if the customer is categorized as a new customer;
record the customer menu selections made by said new customer in said customer profile;
store said customer profile in said data repository for future retrieval;
categorize the customer as an existing customer if said unique customer identity code matches any of said existing unique customer identity codes from said existing customer list;
retrieve a customer profile corresponding to said unique customer identity code from said data repository if the customer is categorized as an existing customer;
create a custom menu comprising previous customer menu selection items stored in said customer profile if said customer is categorized as an existing customer;
display said custom menu to said existing customer on display means proximate said main menu board; and,
record the customer menu selections made by said existing customer in said customer profile;
store said customer profile in said data repository for future retrieval.

19. A computer program product as defined by claim 18 wherein said machine readable identity means comprise a license plate, and wherein said unique customer identity code comprises a license plate number.
